(19) United States
(12) Patent Application Publication
(10) Pub. No.: US 2014/0047221 A1
(43) Pub. Date: Feb. 13, 2014

(54) FUSING FLAG-PRODUCING AND FLAG-CONSUMING INSTRUCTIONS IN INSTRUCTION PROCESSING CIRCUITS, AND RELATED PROCESSOR SYSTEMS, METHODS, AND COMPUTER-READABLE MEDIA

(71) Applicant: QUALCOMM INCORPORATED, San Diego, CA (US)

(72) Inventors: Andrew S. Irwin, Raleigh, NC (US); James Norris Dieffenderfer, Apex, NC (US); Melinda J. Brown, Raleigh, NC (US); Jeffery M. Schottmiller, Raleigh, NC (US); Brian Michael Stempel, Raleigh, NC (US); Michael Scott McIlvaine, Raleigh, NC (US); Rodney Wayne Smith, Raleigh, NC (US); Michael William Morrow, Wilkes-Barre, PA (US)

(73) Assignee: QUALCOMM INCORPORATED, San Diego, CA (US)

(21) Appl. No.: 13/788,008

(22) Filed: Mar. 7, 2013

Related U.S. Application Data
(60) Provisional application No. 61/680,441, filed on Aug. 7, 2012.

(51) Int. Cl. G06F 9/30

(52) U.S. Cl. CPC G06F 9/30181
USPC 712/226

(57) ABSTRACT

Fusing flag-producing and flag-consuming instructions in instruction processing circuits and related processor systems, methods, and computer-readable media are disclosed. In one embodiment, a flag-producing instruction indicating a first operation generating a first flag result is detected in an instruction stream by an instruction processing circuit. The instruction processing circuit also detects a flag-consuming instruction in the instruction stream indicating a second operation consuming the first flag result as an input. The instruction processing circuit generates a fused instruction indicating the first operation generating the first flag result and indicating the second operation consuming the first flag result as the input. In this manner, as a non-limiting example, the fused instruction eliminates a potential for a read-after-write hazard between the flag-producing instruction and the flag-consuming instruction.

### PRIORITY APPLICATION

The present application claims priority to U.S. Provisional Patent Application Ser. No. 61/680,441 filed on Aug. 7, 2012 and entitled “FUSING FLAG-PRODUCING AND FLAG-CONSUMING INSTRUCTIONS IN INSTRUCTION PROCESSING CIRCUITS, AND RELATED PROCESSOR SYSTEMS, METHODS, AND COMPUTER-READABLE MEDIA,” which is hereby incorporated herein by reference in its entirety.

### BACKGROUND

I. Field of the Disclosure

The technology of the disclosure relates generally to processing of pipelined computer instructions in central processing unit (CPU)-based systems.

II. Background

The advent of “instruction pipelining” in modern computer architectures has yielded improved utilization of central processing unit (CPU) resources and faster execution times of computer applications. Instruction pipelining is a processing technique whereby a throughput of computer instructions being processed by a CPU may be increased by splitting the processing of each instruction into a series of steps. The instructions are executed in an “execution pipeline” composed of multiple stages, with each stage carrying out one of the steps for each of a series of instructions. As a result, in each CPU clock cycle, steps for multiple instructions can be evaluated in parallel. A CPU may optionally employ multiple execution pipelines to further boost performance.

Circumstances may arise wherein an instruction is prevented from executing during its designated CPU clock cycle in an execution pipeline. For instance, a data dependency may exist between a first instruction and a subsequent instruction (i.e., the subsequent instruction may consume a result produced by can operation provided by the first instruction). If the first instruction has not completely executed prior to execution of the subsequent instruction, the result required by the subsequent instruction may not yet be available when the subsequent instruction executes. Consequently, a pipeline “hazard” (specifically, a “read after write hazard”) may occur.

To resolve this hazard, the CPU may “stall” or delay execution of the subsequent instruction until the first instruction has completely executed, which decreases the effective throughput of the CPU. To avoid stalling of the subsequent instruction, the CPU may alternatively employ a technique known as “pipeline forwarding.” Pipeline forwarding can prevent a need for execution pipeline stalling by allowing a result of the first executed instruction to be accessed by the subsequent instruction without requiring the result to be written to a register and then read back from the register by the subsequent instruction.

### SUMMARY OF THE DISCLOSURE

Embodiments of the disclosure provide fusing flag-producing and flag-consuming instructions in instruction processing circuits. Related processor systems, methods, and computer-readable media are also disclosed. In this regard, in one embodiment, an instruction processing circuit is provided. The instruction processing circuit is configured to detect a flag-producing instruction in an instruction stream indicating a first operation generating a first flag result. The instruction processing circuit is also configured to detect a flag-consuming instruction in the instruction stream indicating a second operation consuming the first flag result as an input. The instruction processing circuit is further configured to generate a fused instruction indicating the first operation generating the first flag result and indicating the second operation consuming the first flag result as the input. In this manner, as a non-limiting example, generation of the fused instruction internally consuming the first flag result improves performance of a central processing unit (CPU) by eliminating a potential for a read-after-write hazard between the flag-producing instruction and the flag-consuming instruction and associated consequences caused by dependencies between the instructions in a pipelined computing architecture.

In another embodiment, an instruction processing circuit is provided. The instruction processing circuit comprises a means for detecting a flag-producing instruction in an instruction stream indicating a first operation generating a first flag result. The instruction processing circuit also comprises a means for detecting a flag-consuming instruction in the instruction stream indicating a second operation consuming the first flag result as an input. The instruction processing circuit further comprises a means for generating a fused instruction indicating the first operation generating the first flag result and indicating the second operation consuming the first flag result as the input.

In another embodiment, a method for processing computer instructions is provided. The method comprises detecting a flag-producing instruction in an instruction stream indicating a first operation generating a first flag result. The method also comprises detecting a flag-consuming instruction in the instruction stream indicating a second operation consuming the first flag result as an input. The method further comprises generating a fused instruction indicating the first operation generating the first flag result and indicating the second operation consuming the first flag result as the input.

In another embodiment, a non-transitory computer-readable medium is provided. The non-transitory computer-readable medium has stored thereon computer-executable instructions to cause a processor to implement a method for detecting a flag-producing instruction in an instruction stream indicating a first operation generating a first flag result. The method implemented by the computer-executable instructions further comprises detecting a flag-consuming instruction in the instruction stream indicating a second operation consuming the first flag result as an input. The method implemented by the computer-executable instructions also comprises generating a fused instruction indicating the first operation generating the first flag result and indicating the second operation consuming the first flag result as the input.

### BRIEF DESCRIPTION OF THE FIGURES

FIG. 1 is a block diagram of exemplary components provided in a processor-based system for retrieving and processing computer instructions to be placed into one or more execution pipelines, including an exemplary instruction processing circuit configured to fuse a flag-producing instruction and a flag-consuming instruction;

FIG. 2 is a diagram illustrating an exemplary fused instruction generated based on detecting a flag-producing instruction and a flag-consuming instruction;

FIG. 3 is a flowchart illustrating an exemplary process of an instruction processing circuit for generating a fused instruction based on detecting a flag-producing instruction and a flag-consuming instruction;

FIGS. 4A and 4B are flowcharts illustrating a more detailed exemplary process of an instruction processing circuit for detecting and fusing a flag-producing instruction and a flag-consuming instruction;

FIG. 5 is a diagram illustrating exemplary instruction streams having a non-fusible combination of a flag-producing instruction and a flag-consuming instruction;

FIG. 6 is a diagram illustrating exemplary fused instructions generated based on a flag-producing instruction and a flag-consuming instruction;

FIG. 7 is a diagram illustrating other exemplary fused instructions generated based on a flag-producing instruction and a flag-consuming instruction;

FIG. 8 is a diagram illustrating exemplary instruction streams including a fused instruction generated based on a flag-producing instruction and a flag-consuming instruction;

FIG. 9 is a diagram illustrating an exemplary fused instruction generated based on non-consecutive flag-producing and flag-consuming instructions;

FIG. 10 is a diagram illustrating a further exemplary fused instruction generated based on flag-producing and flag-consuming instructions according to some embodiments; and

FIG. 11 is a block diagram of an exemplary processor-based system that can include instruction processing circuits, including the instruction processing circuit of FIG. 1, configured to detect a flag-producing instruction and a flag-consuming instruction and further configured to generate a fused instruction.

### DETAILED DESCRIPTION

With reference now to the drawing figures, several exemplary embodiments of the present disclosure are described. The word “exemplary” is used herein to mean “serving as an example, instance, or illustration.” Any embodiment described herein as “exemplary” is not necessarily to be construed as preferred or advantageous over other embodiments. It is also to be understood that, although the terms “first,” “second,” etc. may be used herein to describe various elements, these terms are only used to distinguish one element from another, and the elements thus distinguished are not to be limited by these terms. For example, a first instruction could be termed a second instruction, and, similarly, a second instruction could be termed a first instruction, without departing from the teachings of the disclosure.

Embodiments of the disclosure provide fusing flag-producing and flag-consuming instructions in instruction processing circuits. Related processor systems, methods, and computer-readable media are also disclosed. In this regard, in one embodiment, an instruction processing circuit is provided. The instruction processing circuit is configured to detect a flag-producing instruction in an instruction stream indicating a first operation generating a first flag result. The instruction processing circuit is also configured to detect a flag-consuming instruction in the instruction stream indicating a second operation consuming the first flag result as an input. The instruction processing circuit is further configured to generate a fused instruction indicating the first operation generating the first flag result and indicating the second operation consuming the first flag result as the input. In this manner, as a non-limiting example, generation of the fused instruction internally consuming the first flag result improves performance of a central processing unit (CPU) by eliminating a potential for a read-after-write hazard between the flag-producing instruction and the flag-consuming instruction and associated consequences caused by dependencies between the instructions in a pipelined computing architecture.

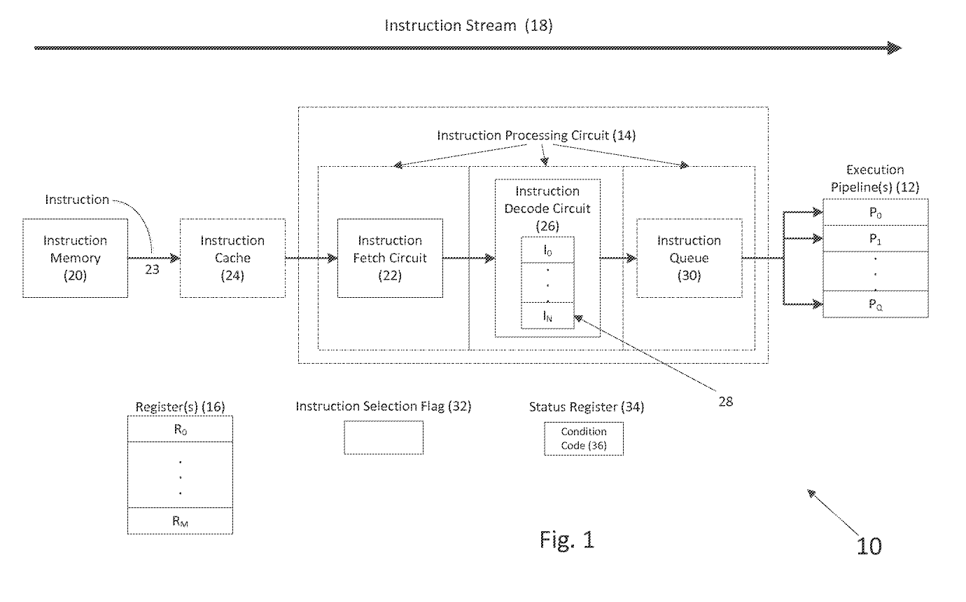

In this regard, FIG. 1 is a block diagram of an exemplary processor-based system 10 for retrieving and processing computer instructions to be placed into one or more execution pipelines 12(0)-12(Q). The processor-based system 10 provides an instruction processing circuit 14 that is configured to generate a fused instruction based on a flag-producing instruction and a flag-consuming instruction. Before this process is described in greater detail, operation of the instruction processing circuit 14 for processing instructions is discussed. As used herein, an “instruction” may refer to a combination of bits defined by an instruction set architecture that direct a computer processor to carry out a specified task or tasks. For example, an instruction may indicate operations for reading data from and/or writing data to registers 16(0)-16(M), which provide local storage accessible by the processor-based system 10. Exemplary instruction set architectures include, but are not limited to, ARM, Thumb, and A64 architectures.

With continuing reference to FIG. 1, instructions are processed in the processor-based system 10 in a continuous flow represented by an instruction stream 18. The instruction stream 18 may be continuously processed as the processor-based system 10 is operating and executing the instructions. In this illustrated example, the instruction stream 18 begins with an instruction memory 20, which provides persistent storage for instructions in a computer-executable program.

An instruction fetch circuit 22 reads an instruction represented by arrow 23 (hereinafter “instruction 23”) from the instruction memory 20 and/or optionally from an instruction cache 24. The instruction fetch circuit 22 may increment a program counter (not shown), typically stored in one of the registers 16(0)-16(M). The instruction cache 24 is an optional buffer that may be provided and coupled to the instruction memory 20 and to the instruction fetch circuit 22 to allow direct access to cached instructions by the instruction fetch circuit 22. The instruction cache 24 may speed up instruction retrieval times, but at a cost of potentially incurring longer read times if an instruction has not been previously stored in the instruction cache 24.

Once the instruction 23 is fetched by the instruction fetch circuit 22, the instruction 23 proceeds to an instruction decode circuit 26 that translates the instruction 23 into processor-specific microinstructions. In this embodiment, the instruction decode circuit 26 stores a group of multiple instructions 28(0)-28(N) simultaneously for decoding. After the instructions 28(0)-28(N) have been fetched and decoded, they are optionally issued to an instruction queue 30, which serves as a buffer for storing the instructions 28(0)-28(N). The instructions 28(0)-28(N) are then issued to one of the execution pipelines 12(0)-12(Q) for execution. In some embodiments, the execution pipelines 12(0)-12(Q) may restrict the types of operations carried out by instructions that execute within the execution pipelines 12(0)-12(Q). For example, pipeline P₀ may not permit read access to the registers 16(0)-16(M). Accordingly, an instruction that indicates an operation to read register R₀ may only be issued to one of the execution pipelines P₁ through P_{Q}.

The instruction processing circuit 14 may be any type of device or circuit, and may be implemented or performed with a processor, a digital signal processor (DSP), an Application Specific Integrated Circuit (ASIC), a field-programmable gate array (FPGA) or other programmable logic device, discrete gate or transistor logic, discrete hardware components, or any combination thereof designed to perform the functions described herein. In some embodiments, the instruction processing circuit 14 is incorporated into the instruction fetch circuit 22, the instruction decode circuit 26, and/or the optional instruction queue 30.

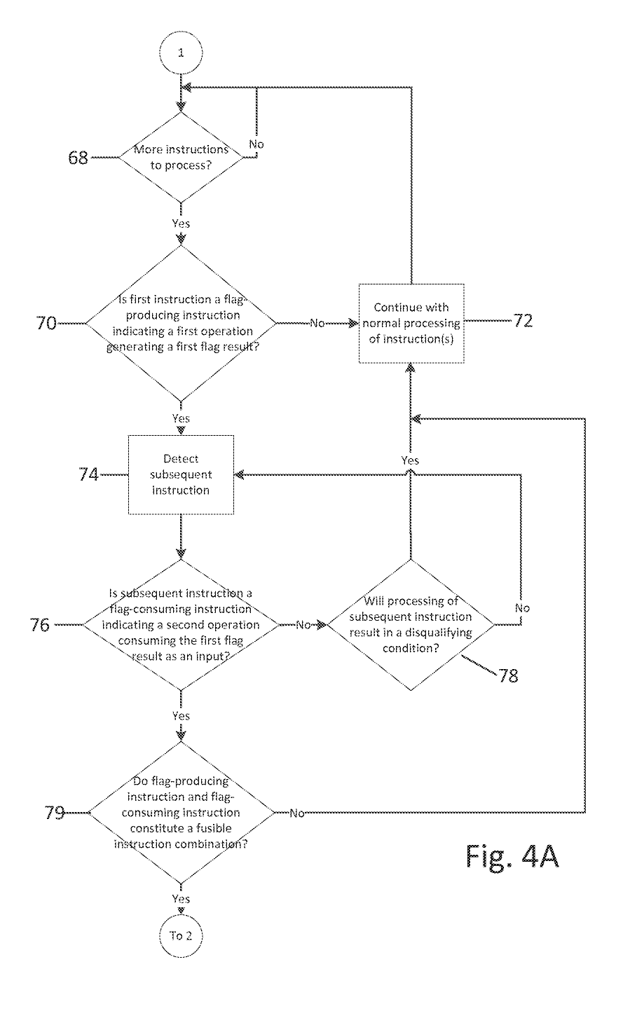

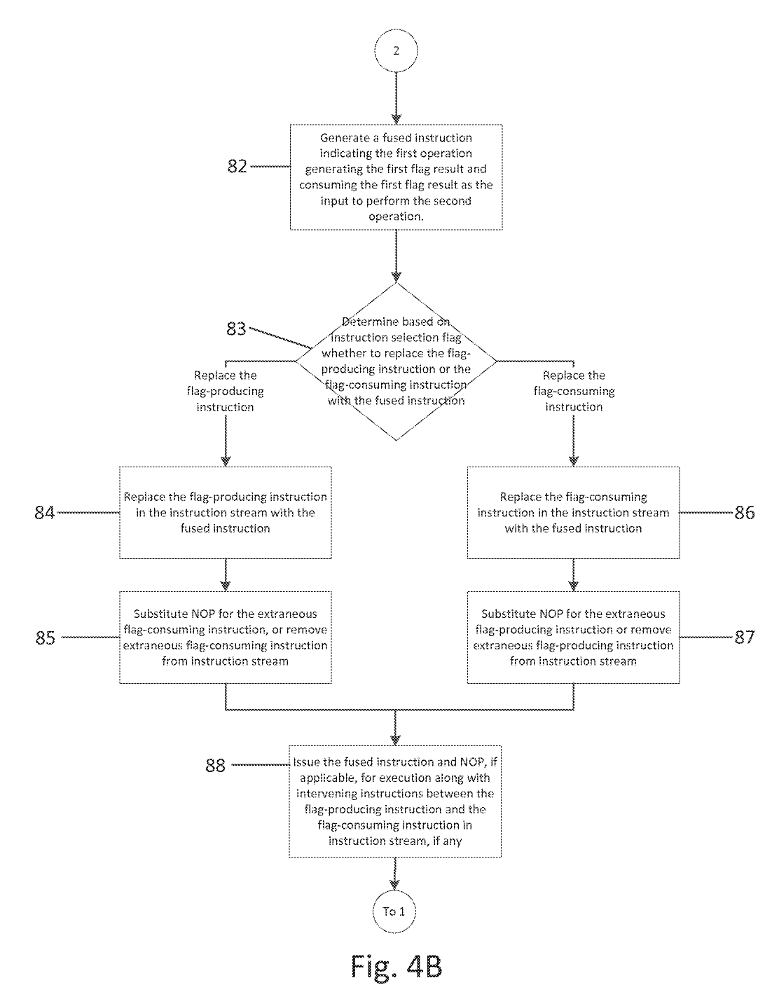

With continuing reference to FIG. 1, the instruction processing circuit 14 in this example is configured to detect a flag-producing instruction and a flag-consuming instruction, and generate a fused instruction to facilitate forwarding of a first flag result, thereby removing a potential for a read-after-write hazard and associated consequences caused by dependencies between the instructions in a pipelined computing architecture. The instruction processing circuit 14 may employ an instruction selection flag 32 to determine which detected flag-producing instruction or flag-consuming instruction may be replaced in the instruction stream 18 by the fused instruction, as will be discussed in more detail with respect to FIG. 4B. Additionally, some embodiments of the instruction processing circuit 14 may provide a status register 34 for storing a condition code 36, which represents information related to a state of the instructions executing in the instruction stream 18 (e.g., conditions resulting from a comparison, data processing, or arithmetic calculation). In some embodiments, the condition code 36 comprises a negative (N) flag, a zero (Z) flag, a carry (C) flag, and/or an overflow (V) flag.

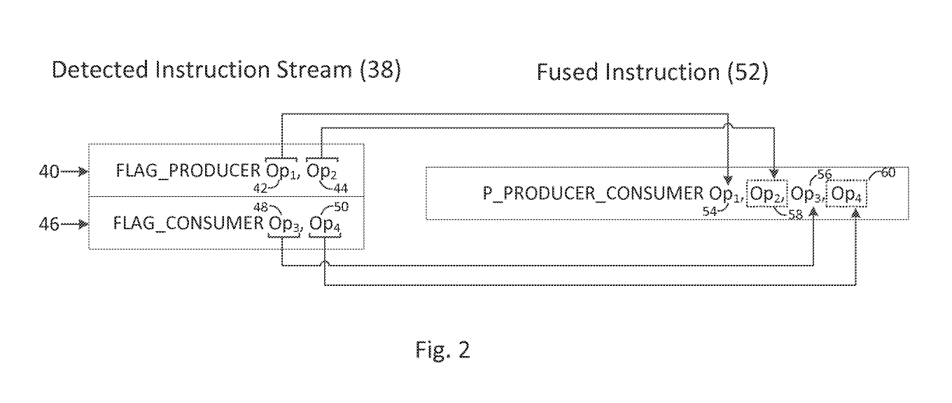

To provide an explanation of an exemplary process for fusing a flag-producing instruction and a flag-consuming instruction in the processor-based system 10 of FIG. 1, FIG. 2 is provided. In this example, a detected instruction stream 38 represents a series of instructions fetched from the instruction stream 18 and detected by the instruction processing circuit 14 of FIG. 1. First in the detected instruction stream 38 is a FLAG_PRODUCER instruction 40, which represents an instruction performing a first operation using operands 42 and 44 and generating a flag result based on the result of the first operation. The operands 42 and 44, referred to respectively as Op₁ and Op₂, may each be one of the registers 16(0)-16(M) of FIG. 1. Alternatively, Op₁ may be one of the registers 16(0)-16(M) while Op₂ may be a zero or non-zero immediate value. In some embodiments, the FLAG_PRODUCER instruction 40 may include more or fewer operands than the operands Op₁ and Op₂ depicted in this example.

Some embodiments disclosed herein may provide that the first operation comprises a comparison, data processing, or arithmetic calculation using Op₁ and Op₂, and that generating a flag result comprises setting the condition code 36 in the status register 34 of FIG. 1 to indicate a result of the first operation. Accordingly, the FLAG_PRODUCER instruction 40 may comprise an instruction, such as the ARM architecture CMP (compare) instruction, for comparing values designated by the operands Op₁ and Op₂. Alternatively, the FLAG_PRODUCER instruction 40 may comprise a data processing or arithmetic operation instruction that also updates the condition code 36 in the status register 34, such as the ARM architecture ADDS (add and set flags) instruction. In some embodiments, the FLAG_PRODUCER instruction 40 sets the condition code 36 by setting or clearing one or more of the N, Z, C, and/or V flags of the condition code 36 based on the result of the first operation using the operands Op₁ and Op₂.

Further along in the detected instruction stream 38 is a FLAG_CONSUMER instruction 46. The FLAG_CONSUMER instruction 46 represents a second operation using operands 48 and 50 and consuming the flag result generated by the FLAG_PRODUCER instruction 40 as an input. The operands 48 and 50, referred to respectively as Op₃ and Op₄, may each be one of the registers 16(0)-16(M) of FIG. 1. Alternatively, the operand Op₃ may be one of the registers 16(0)-16(M) while the operand Op₄ may be a zero or non-zero immediate value. In some embodiments, the FLAG_CONSUMER instruction 46 may include more or fewer operands than the operands Op₃ and Op₄ depicted in this example.

As used herein, to “consume” a flag result means to access the flag result, evaluate the flag result based on a condition, and conditionally perform an operation depending upon a result of the evaluation. For example, the FLAG_CONSUMER instruction 46 may comprise an ARM architecture instruction that consumes a flag result by applying one of the conditions listed in Table 1 below to evaluate the condition code 36 of the status register 34 of FIG. 1. If the applied condition evaluates to true, then the FLAG_CONSUMER instruction 46 may perform an operation; if the applied condition evaluates to false, no operation is performed by the FLAG_CONSUMER instruction 46. It is to be understood that the conditions listed in Table 1 are non-limiting examples, and that some embodiments may define other conditions and/or corresponding condition codes. It is to be further understood that the FLAG_CONSUMER instruction 46 may be fetched immediately following the FLAG_PRODUCER instruction 40 in the detected instruction stream 38, or the FLAG_CONSUMER instruction 46 and the FLAG_PRODUCER instruction 40 may be separated in the detected instruction stream 38 by other intervening instructions.

TABLE 1
Exemplary Conditions and Corresponding Condition Codes

| Condition | Meaning | Status of Condition Code Bits |
|---|---|---|
| EQ | Equal | Z bit set |
| NE | Not equal | Z bit clear |
| HS/CS | Unsigned higher or same | C bit set |
| LO/CC | Unsigned lower | C bit clear |
| MI | Negative | N bit set |
| PL | Positive or zero | N bit clear |
| VS | Overflow | V bit set |
| VC | No overflow | V bit clear |
| HI | Unsigned higher | C bit set and Z bit clear |
| LS | Unsigned lower or same | C bit clear or Z bit set |
| GE | Greater or equal | N bit set and V bit set, or |
| | | N bit clear and V bit clear |
| LT | Less than | N bit set and V bit clear, or |
| | | N bit clear and V bit set |
| GT | Greater than | Z bit clear, and either |
| | | N bit set and V bit clear, or |
| | | N bit clear and V bit set |
| LE | Less than or equal | Z bit set, or |
| | | N bit set and V bit clear, or |
| | | N bit clear and V bit set |

In some embodiments, the FLAG_CONSUMER instruction 46 may consume the flag result generated by the FLAG_PRODUCER instruction 40, and also generate a new flag result as a result of the second operation on operands Op₃ and Op₄. For instance, the FLAG_CONSUMER instruction 46 may comprise the ARM architecture CMPEQ (compare if equal) instruction, which consumes the flag result in the condition code 36 of the status register 34 of FIG. 1 by applying the EQ (equals) condition to the flag result. If the EQ condition evaluates to true, the CMPEQ instruction may generate a new flag result based on a comparison of the values designated by the operands Op₃ and Op₄. Some embodiments may provide that the FLAG_CONSUMER instruction 46 may consume the flag result generated by the FLAG_PRODUCER instruction 40, and perform a second operation that does not generate a flag result. For example, the FLAG_CONSUMER instruction 46 may comprise the ARM architecture MOVEQ (move if equal) instruction, which indicates an operation consuming the flag result in the condition code 36 by applying the EQ condition to the flag result. If the EQ condition evaluates to true, the MOVEQ instruction moves a value represented by the operand Op₄ into a register designated by the operand Op₃, without generating a new flag result.

With continued reference to FIG. 2, the instruction processing circuit 14 of FIG. 1 generates a fused instruction 52, which in this example is a P_PRODUCER_CONSUMER (“paired flag result producer/consumer”) instruction. The P_PRODUCER_CONSUMER fused instruction 52 reproduces the functionality of both the FLAG_PRODUCER instruction 40 and the FLAG_CONSUMER instruction 46. In particular, the P_PRODUCER_CONSUMER fused instruction 52 indicates a first operation of the FLAG_PRODUCER instruction 40 generating a flag result, and consumes the flag result as an input to perform a second operation of the FLAG_CONSUMER instruction 46. In this manner, the P_PRODUCER_CONSUMER fused instruction 52 ensures that the functionality of both the FLAG_PRODUCER instruction 40 and the FLAG_CONSUMER instruction 46 executes within a single execution pipeline 12, thus eliminating a potential for a read-after-write hazard and associated consequences caused by dependencies between the instructions in a pipelined computing architecture. In some embodiments, the P_PRODUCER_CONSUMER fused instruction 52 performs the operations of the FLAG_PRODUCER instruction 40 in one execution stage of an execution pipeline 12. The P_PRODUCER_CONSUMER fused instruction 52 then forwards the generated flag result to a subsequent execution stage of the execution pipeline 12, where the P_PRODUCER_CONSUMER fused instruction 52 performs the operations of the FLAG_CONSUMER instruction 46.

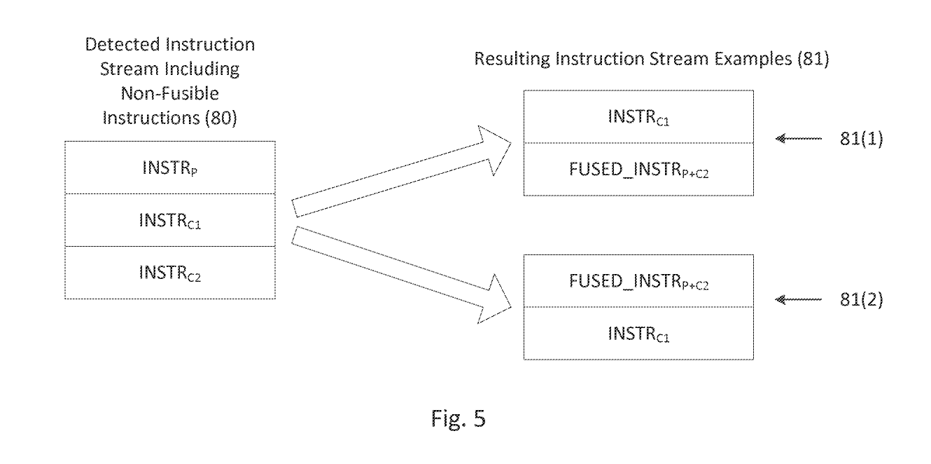

The P_PRODUCER_CONSUMER fused instruction 52 includes operands 54 and 56 corresponding to the operands Op₁ and Op₃, respectively. In some embodiments, the P_PRODUCER_CONSUMER fused instruction 52 may also include one or both of operands 58 and 60 corresponding to the operands Op₂ and Op₄, respectively, depending upon a number of factors. These factors may include: the functionality of the FLAG_PRODUCER instruction 40 and the FLAG_CONSUMER instruction 46; the type of the operands Op₂ and Op₄ (e.g., registers, immediate values, etc.); and/or the number of operands allowed by the computer architecture on which the instructions execute. For instance, if the operand Op₂ represents an immediate value of zero, the P_PRODUCER_CONSUMER fused instruction 52 may omit the operand 58. Exemplary fused instructions having various combinations of operands are discussed in more detail below with respect to FIGS. 5-8.

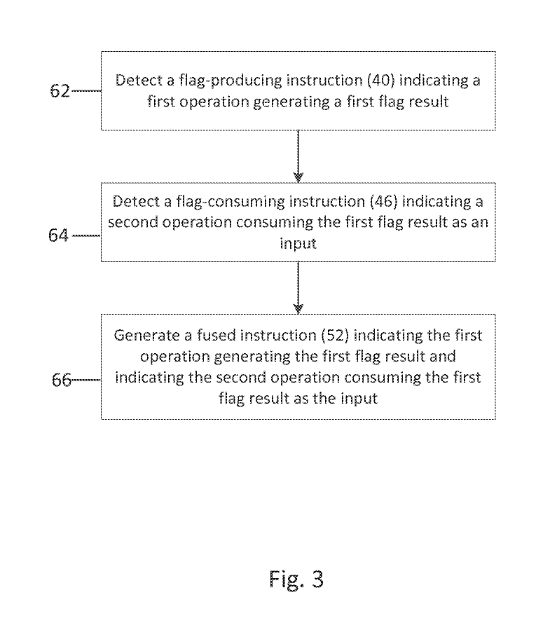

To further illustrate fusing a flag-producing instruction and a flag-consuming instruction, an exemplary generalized process for an instruction processing circuit configured to detect flag-producing and flag-consuming instructions and generate a fused instruction is illustrated by FIG. 3. The discussion of the example in FIG. 3 is made with further reference to FIGS. 1 and 2. In FIG. 3, the process begins by the instruction processing circuit 14 of FIG. 1 detecting a flag-producing instruction (such as the FLAG_PRODUCER instruction 40 of FIG. 2) indicating a first operation generating a first flag result (block 62). The instruction processing circuit 14 next detects a flag-consuming instruction (such as the FLAG_CONSUMER instruction 46 of FIG. 2) consuming the first flag result as an input for performing a second operation (block 64). The instruction processing circuit 14 then generates a fused instruction (e.g., the P_PRODUCER_CONSUMER fused instruction 52) indicating the first operation generating the first flag result and indicating the second operation consuming the first flag result as the input (block 66).

FIGS. 4A and 4B illustrate a more detailed exemplary process of an instruction processing circuit, including the instruction processing circuit 14 of FIG. 1, for detecting a flag-producing instruction and a flag-consuming instruction, and for generating a fused instruction. FIG. 4A details a process for determining whether a flag-producing instruction and a flag-consuming instruction that may be fused are detected in an instruction stream. FIG. 4B shows operations for generating a fused instruction and replacing one of the flag-producing or flag-consuming instructions in the instruction stream with the generated fused instruction. For illustrative purposes, FIGS. 4A and 4B refer to elements of the exemplary processor-based system 10 and the instruction processing circuit 14 of FIG. 1, as well as the exemplary process described above with respect to FIG. 2.

The process in this example begins in FIG. 4A with the instruction processing circuit 14 detecting whether another instruction (such as the instruction 23 of FIG. 1) remain to be processed in the instruction stream 18 (block 68 of FIG. 4A). In some embodiments, this detection process is accomplished by detecting the presence of unprocessed instructions in an instruction fetch circuit and/or an instruction decode circuit (such as the instruction fetch circuit 22 and/or the instruction decode circuit 26, respectively, of FIG. 1). If no instruction is detected, the instruction processing circuit 14 returns to block 68 of FIG. 4A.

If an instruction is detected, the instruction processing circuit 14 determines whether the first detected instruction is a flag-producing instruction (such as the FLAG_PRODUCER instruction 40 of FIG. 2) indicating a first operation generating a first flag result (block 70 of FIG. 4A). Detection of the flag-producing instruction indicates that the instruction processing circuit 14 may be able to convert the first detected instruction and a subsequent flag-consuming instruction (e.g., the FLAG_CONSUMER instruction 46 of FIG. 2) within the instruction stream 18 into a fused instruction, such as the P_PRODUCER_CONSUMER fused instruction 52 of FIG. 2. In the event that the first detected instruction is not a flag-producing instruction, there is no opportunity for generating a fused instruction, and processing of the first detected instruction continues (block 72 of FIG. 4A). The instruction processing circuit 14 then returns to block 68 of FIG. 4A.

Returning to the decision point at block 70 of FIG. 4A, if the first detected instruction is a flag-producing instruction, the instruction processing circuit 14 detects a subsequent instruction in the instruction stream 18 (block 74 of FIG. 4A). The instruction processing circuit 14 then determines whether the subsequent detected instruction is a flag-consuming instruction indicating a second operation that consumes the first flag result as an input (block 76 of FIG. 4A). If the subsequent detected instruction is not a flag-consuming instruction that consumes the first flag result, it is not a candidate for fusion with the flag-producing instruction. However, it may still be possible for another flag-consuming instruction fetched from further along in the instruction stream 18 (i.e., a flag-consuming instruction not adjacent to the flag-producing instruction in the instruction stream 18) to be detected and used to generate a fused instruction 52.

In preparation for such a possibility, the instruction processing circuit 14 determines whether processing of the subsequent detected instruction will result in an occurrence of a disqualifying condition (block 78 of FIG. 4A). A disqualifying condition may be any condition introduced by the subsequent detected instruction that makes fusion of the flag-producing instruction and a later-detected flag-consuming instruction impossible. For example, a disqualifying condition may occur if the subsequent detected instruction alters the flow of the computer program such that it is impossible to guarantee that both or neither of the flag-producing instruction and a later-detected flag-consuming instruction will be executed. Depending upon whether the flag-producing instruction or the flag-consuming instruction is to be removed or replaced with an NOP, a disqualifying condition may also result if the subsequent detected instruction modifies or consumes a flag or non-flag result of the flag-producing instruction, or if the subsequent detected instruction modifies a non-flag source of the flag-consuming instruction. In such case, the fused instruction may not be able to reproduce the functionality of the flag-producing instruction and the flag-consuming instruction. If a disqualifying condition is detected at block 78 of FIG. 4A, processing of the flag-producing instruction and the subsequent detected instruction continues (block 72 of FIG. 4A), and the instruction processing circuit 14 then returns to block 68 of FIG. 4A.

If the instruction processing circuit 14 determines at block 78 of FIG. 4A that processing of the subsequent detected instruction will not result in the occurrence of a disqualifying condition, the instruction processing circuit 14 returns to block 74 of FIG. 4A, where another subsequent instruction is detected in the instruction stream 18. As seen in FIG. 4A, this process then repeats as described above until either the instruction processing circuit 14 detects a subsequent instruction that satisfies the criteria in block 76, the instruction processing circuit 14 detects a subsequent instruction that triggers a disqualifying condition in block 78, or there are no more instructions to be processed.

Returning to the decision point at block 76 of FIG. 4A, if the subsequent detected instruction is a flag-consuming instruction indicating a second operation consuming the first flag result as an input, the instruction processing circuit 14 next determines whether the flag-producing instruction and the flag-consuming instruction together constitute a fusible instruction combination (block 79). Some embodiments may permit only particular pairs of instructions or only pairs of instructions having particular types of operands to be used for generating a fused instruction. Moreover, some embodiments may provide that if a previously detected flag-producing instruction is determined not to be fusible with a detected flag-consuming instruction, the detected flag-producing instruction may not be fused with another subsequent detected flag-consuming instruction. This is because it may not be possible to insert a fused instruction into the instruction stream such that the functionality of the flag-producing instruction and the flag-consuming instruction are all accurately reproduced.

As illustrated in FIG. 5, for instance, assume that a detected instruction stream 80 includes a flag-producing instruction INSTR_{P}, a first subsequent flag-consuming instruction INSTR_{C1}, and a second subsequent flag-consuming instruction INSTR_{C2}. Assume further that INSTR_{P} and INSTR_{C1} are not fusible, but an attempt is made to fuse INSTR_{P} and INSTR₂. The resulting instruction stream examples 81 illustrate the issues that may result. If a resulting fused instruction FUSED_INSTR_{P+C2} replaces INSTR_{C2} in the instruction stream as shown in instruction stream 81(1), then the condition code flag on which INSTR_{C1} depends may not be generated until after INSTR_{C1} has executed. However, if the resulting fused instruction replaces INSTR_{P} instead as seen in instruction stream 81(2) and INSTR_{C2} also generates a flag result, INSTR_{C1} may consume an incorrect flag result generated by the fused instruction FUSED_INSTR_{P+C2} when it carries out the operations of INSTR_{P} and INSTR_{C2}.

Accordingly, if the instruction processing circuit 14 determines at block 79 of FIG. 4A that the flag-producing instruction and the flag-consuming instruction do not constitute a fusible instruction combination, the instruction processing circuit 14 returns to block 72 of FIG. 4A to search anew for another flag-producing instruction to pair with a subsequent flag-consuming instruction. At block 72, the instruction processing circuit 14 processes the flag-producing instruction and the flag-consuming instruction as separate, individual instructions. Processing then resumes at block 68 of FIG. 4A.

If the instruction processing circuit 14 determines at block 79 of FIG. 4A that the flag-producing instruction and the flag-consuming instruction constitute a fusible instruction combination, the instruction processing circuit 14 proceeds to block 82 of FIG. 4B. It is to be understood that, at this point, the flag-producing instruction and the flag-consuming instruction may have been fetched adjacently from the instruction stream 18, or they may have been separated in the instruction stream 18 by other intervening (but not disqualifying) instructions. FIG. 4B is provided to illustrate operations for generating a fused instruction, and replacing one of the flag-producing instruction and the flag-consuming instruction in the instruction stream 18 with a generated fused instruction. In FIG. 4B, the instruction processing circuit 14 generates a fused instruction indicating the first operation generating the first flag result and indicating the second operation consuming the first flag result as the input (block 82 of FIG. 4B).

After generating the fused instruction, the instruction processing circuit 14 determines, based on an instruction selection flag (such as the instruction selection flag 32 of FIG. 1), whether to replace the flag-producing instruction or the flag-consuming instruction in the instruction stream 18 with the fused instruction (block 83 of FIG. 4B). In some embodiments, the instruction selection flag 32 may indicate that either the flag-producing instruction or the flag-consuming instruction is always replaced. If the instruction selection flag indicates that the flag-producing instruction should be replaced, the instruction processing circuit 14 replaces the flag-producing instruction in the instruction stream 18 with the fused instruction (block 84 of FIG. 4B). The fused instruction renders the flag-consuming instruction extraneous. Therefore, the instruction processing circuit 14 substitutes an instruction indicating no operation (i.e., NOP) for the extraneous flag-consuming instruction, or removes the extraneous flag-consuming instruction from the instruction stream 18 (block 85 of FIG. 4B).

Returning to the decision point at block 83 of FIG. 4B, if the instruction selection flag indicates that the flag-consuming instruction should be replaced, the instruction processing circuit 14 replaces the flag-consuming instruction in the instruction stream 18 with the fused instruction (block 86 of FIG. 4B). Because the fused instruction renders the flag-producing instruction extraneous, the instruction processing circuit 14 substitutes an instruction indicating no operation (i.e., NOP) for the extraneous flag-producing instruction, or removes the extraneous flag-producing instruction from the instruction stream 18 (block 87 of FIG. 4B).

After the instruction processing circuit 14 replaces either the flag-producing instruction or the flag-consuming instruction and replaces or removes the corresponding extraneous instruction, the fused instruction may then be issued for execution (block 88 of FIG. 4B). If any intervening non-disqualifying instructions were previously detected between the flag producing instruction and the flag-consuming instruction in the instruction stream 18 at decision block 78 of FIG. 4A, those intervening instructions may also be processed and issued for execution. If an extraneous instruction was replaced with a NOP at block 85 or block 87 of FIG. 4B, the NOP may also be issued for execution at block 88 of FIG. 4B. Processing then resumes at block 68 of FIG. 4A.

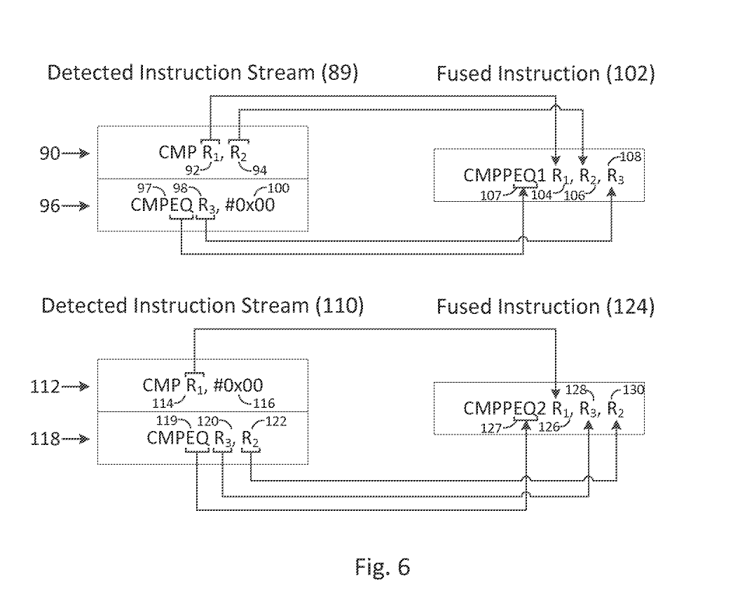

To better illustrate an exemplary generation of a fused instruction based on a flag-producing instruction and a flag-consuming instruction in some embodiments, FIG. 6 is provided. In FIG. 6, a detected instruction stream 89 depicts a series of instructions detected by the instruction processing circuit 14 as the instruction stream 18 of FIG. 1 is processed. Detected first in the detected instruction stream 89 is a flag-producing instruction 90, which in this example is the ARM architecture CMP instruction. The CMP flag-producing instruction 90 sets the condition code 36 in the status register 34 of FIG. 1 based on a comparison of values represented by operands 92 and 94. Here, the operands 92 and 94 designate two of the registers 16(0)-16(M) of FIG. 1, referred to as registers R₁ and R₂, respectively. Note that the CMP flag-producing instruction 90 is provided herein as a non-limiting example, and that some embodiments may provide one or more other flag-producing instructions.

Further along in the detected instruction stream 89 of FIG. 6 is a flag-consuming instruction 96, which is the ARM architecture CMPEQ instruction. The CMPEQ flag-consuming instruction 96 consumes the flag result stored in the condition code 36 by applying an EQ (equals) condition 97 to the flag result. It is to be understood that the EQ condition 97 is provided herein as a non-limiting example, and that some embodiments may provide a flag-consuming instruction employing a different condition or operation. As noted above in Table 1, the EQ condition 97 evaluates to true if the Z bit of the condition code 36 is set, and false if the Z bit is clear. If the EQ condition 97 evaluates to true, the CMPEQ flag-consuming instruction 96 then carries out the indicated operation. In this example, the operation indicated by the CMPEQ flag-consuming instruction 96 compares a value stored in one of the registers 16(0)-16(M) designated by an operand 98 (referred to in this example as register R₃), and an immediate value of zero designated by an operand 100. Note that, in this example, the CMPEQ flag-consuming instruction 96 is also a flag-producing instruction, because the CMPEQ flag-consuming instruction 96 generates a new flag result in the condition code 36 if the EQ condition 97 applied to the original flag result evaluates to true. However, in some embodiments, a flag-consuming instruction may indicate an operation that consumes a flag result without generating a new flag result.

A fused instruction 102 illustrates the results of processing the CMP flag-producing instruction 90 and the CMPEQ flag-consuming instruction 96 by the instruction processing circuit 14 of FIG. 1. As shown in FIG. 6, the fused instruction 102 is a CMPPEQ1 (“compare (paired) if equal”) instruction that incorporates logic for performing the operations of both the CMP flag-producing instruction 90 and the CMPEQ flag-consuming instruction 96. Accordingly, the CMPPEQ1 fused instruction 102 is distinct from other fused instructions that perform the operations of other combinations of instructions and/or operands. The CMPPEQ1 fused instruction 102 generates a flag result by comparing the values in the registers R₁ and R₂ designated by operands 104 and 106, respectively. The CMPPEQ1 fused instruction 102 then consumes the flag result by applying an EQ condition 107 corresponding to the EQ condition 97 of the CMPEQ flag-consuming instruction 96 to the flag result. If the EQ condition 107 evaluates to true, the CMPPEQ1 fused instruction 102 compares the value in the register R₃, designated by an operand 108, to an immediate value of zero (not shown). By performing the operations of both the CMP flag-producing instruction 90 and the CMPEQ flag-consuming instruction 96 with a single instruction, the CMPPEQ1 fused instruction 102 ensures that the operations are executed within the same execution pipeline 12, thereby avoiding the potential for a read-after-write hazard and associated consequences caused by dependencies between the instructions in a pipelined computing architecture.

As shown in the example in FIG. 6, the immediate value of zero designated by the operand 100 of the CMPEQ flag-consuming instruction 96 is omitted as an operand for the CMPPEQ1 fused instruction 102. In some embodiments, the number of operands that may be associated with the CMPPEQ1 fused instruction 102 are limited by hardware constraints. Accordingly, the logic underlying the CMPPEQ1 fused instruction 102 may be optimized in such a way that the CMPPEQ1 fused instruction 102 may reproduce the functionality of the CMP flag-producing instruction 90 and the CMPEQ flag-consuming instruction 96 without including operands representing an immediate value of zero.

With continuing reference to FIG. 6, generation of a fused instruction is illustrated in an example where the types of operands of a flag-producing instruction and a flag-consuming instruction fetched from the instruction stream 18 of FIG. 1 are reversed. Detected first in a detected instruction stream 110 is a CMP flag-producing instruction 112, which sets the condition code 36 in the status register 34 of FIG. 1 based on a comparison of a value in a register R₁ designated by an operand 114, and an immediate value of zero designated by an operand 116. Note that the CMP flag-producing instruction 112 is provided herein as a non-limiting example, and that some embodiments may provide one or more other flag-producing instructions.

Following the CMP flag-producing instruction 112 in the detected instruction stream 110 of FIG. 6 is a CMPEQ flag-consuming instruction 118. The CMPEQ flag-consuming instruction 118 consumes the flag result in the condition code 36 by applying an EQ condition 119 to the flag result. It is to be understood that the EQ condition 119 is provided herein as a non-limiting example, and that some embodiments may provide a flag-consuming instruction employing a different condition or operation. As noted above, the EQ condition 119 evaluates to true if the Z bit of the condition code 36 is set, and false if the Z bit is clear. If the EQ condition 119 evaluates to true, the CMPEQ flag-consuming instruction 118 executes the indicated operation. In this example, the operation indicated by the CMPEQ flag-consuming instruction 118 compares values stored in registers R₃ and R₂, designated by operands 120 and 122, respectively.

A fused instruction 124 illustrates the results of processing the CMP flag-producing instruction 112 and the CMPEQ flag-consuming instruction 118 by the instruction processing circuit 14 of FIG. 1. As seen in FIG. 6, the fused instruction 124 is a CMPPEQ2 (“compare (paired) if equal”) instruction that incorporates logic for performing the operations of the CMP flag-producing instruction 112 and the CMPEQ flag-consuming instruction 118. Accordingly, the CMPPEQ2 fused instruction 124 is distinct from other fused instructions that perform other combinations of instructions and/or operands, such as the CMPPEQ1 fused instruction 102 discussed above.

The CMPPEQ2 fused instruction 124 generates a flag result by comparing the register R₁ designated by operand 126 with an immediate value of zero (not shown). The CMPPEQ2 fused instruction 124 then consumes the flag result by applying an EQ condition 127, corresponding to the EQ condition 119 of the CMPEQ flag-consuming instruction 118, to the flag result. If the EQ condition 127 evaluates to true, the CMPPEQ2 fused instruction 124 compares the registers R₃ and R₂ designated by operands 128 and 130, respectively. As noted above with respect to the CMPPEQ1 fused instruction 102, the logic underlying the CMPPEQ2 fused instruction 124 may be optimized to enable the CMPPEQ2 fused instruction 124 to perform the operations of the CMP flag-producing instruction 112 and the CMPEQ flag-consuming instruction 118 without including operands representing an immediate value of zero. Accordingly, in this example, the immediate value of zero designated by the operand 116 of the CMP flag-producing instruction 112 is omitted as an operand for the CMPPEQ2 fused instruction 124.

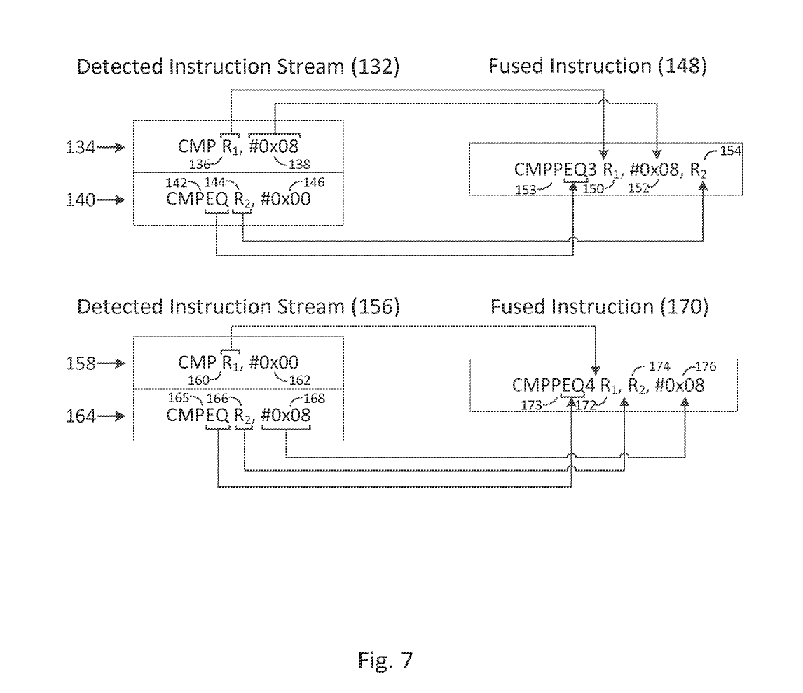

An exemplary fused instruction generated based on flag-producing and flag-consuming instructions having zero and non-zero immediate value operands is shown in FIG. 7, with reference to FIG. 1. In FIG. 7, a detected instruction stream 132 depicts a series of instructions detected by the instruction processing circuit 14 as the instruction stream 18 of FIG. 1 is processed. Detected first in the detected instruction stream 132 is a flag-producing instruction 134, which in this example is the ARM architecture CMP instruction. The CMP flag-producing instruction 134 sets the condition code 36 in the status register 34 based on a comparison of a value stored in one of the registers 16(0)-16(M) of FIG. 1 designated by an operand 136 (referred to as register R₁) and an immediate value having a hexadecimal value of 0x08 designated by an operand 138. Note that the CMP flag-producing instruction 134 is provided herein as a non-limiting example, and that some embodiments may provide one or more other flag-producing instructions. It is to be understood that the immediate value 0x08 designated by the operand 138 is a non-limiting example, and that the operand 138 may designate any immediate value permitted by the instruction set architecture.

Further along in the detected instruction stream 132 is a flag-consuming instruction 140, which in this example is the ARM architecture CMPEQ (“compare if equal”) instruction. The CMPEQ flag-consuming instruction 140 consumes the flag result stored in the condition code 36 by applying an EQ (“equals”) condition 142, which evaluates to true if the Z bit of the condition code 36 is set, and false if the Z bit is clear. It is to be understood that the EQ condition 142 is provided herein as a non-limiting example, and that some embodiments may provide a flag-consuming instruction employing a different condition or operation. If the EQ condition 142 evaluates to true, the CMPEQ flag-consuming instruction 140 then carries out the indicated operation. In this example, the operation indicated by the CMPEQ flag-consuming instruction 140 compares a value stored in one of the registers 16(0)-16(M) of FIG. 1 designated by an operand 144 (referred to as register R₂), and an immediate value of zero designated by an operand 146. Note that, in this example, the CMPEQ flag-consuming instruction 140 is also a flag-producing instruction, because the CMPEQ flag-consuming instruction 140 causes a new flag result to be generated and stored in the condition code 36 if the EQ condition 142 applied to the original flag result evaluates to true. However, it is to be understood that, in some embodiments, a flag-consuming instruction may indicate an operation that consumes a flag result without generating a new flag result.

A fused instruction 148 illustrates the results of processing the CMP flag-producing instruction 134 and the CMPEQ flag-consuming instruction 140 by the instruction processing circuit 14 of FIG. 1. As shown in FIG. 7, the fused instruction 148 is a CMPPEQ3 (“compare (paired) if equal”) instruction that incorporates logic for performing the operations of both the CMP flag-producing instruction 134 and the CMPEQ flag-consuming instruction 140. Accordingly, the CMPPEQ3 fused instruction 148 is distinct from other fused instructions that perform the operations of other combinations of instructions and/or operands, such as the CMPPEQ1 fused instruction 102 and the CMPPEQ2 fused instruction 124 discussed above. The CMPPEQ3 fused instruction 148 generates a flag result by comparing the value in the register R₁ designated by an operand 150 and an immediate value having a hexadecimal value of 0x08 designated by an operand 152, corresponding to the immediate value 0x08 designated by the operand 138 of the CMP flag-producing instruction 134.

The CMPPEQ3 fused instruction 148 then consumes the flag result by applying an EQ condition 153, corresponding to the EQ condition 142 of the CMPEQ flag-consuming instruction 140, to the flag result. If the EQ condition 153 evaluates to true, the CMPPEQ3 fused instruction 148 compares the value in the register R₂ designated by an operand 154 to an immediate value of zero (not shown). By performing the operations of both the CMP flag-producing instruction 134 and the CMPEQ flag-consuming instruction 140 with a single instruction, the CMPPEQ3 fused instruction 148 ensures that the operations are executed within the same execution pipeline 12, thereby eliminating the potential for a read-after-write hazard and associated consequences caused by dependencies between the instructions in a pipelined computing architecture.

As shown in the example in FIG. 7, the immediate value of zero designated by the operand 146 of the CMP flag-consuming instruction 140 is omitted as an operand from the CMPPEQ3 fused instruction 148. As discussed above, in some embodiments, the number of operands that may be associated with the CMPPEQ3 fused instruction 148 are limited by hardware constraints. Accordingly, the logic underlying the CMPPEQ3 fused instruction 148 may be optimized in such a way that the CMPPEQ3 fused instruction 148 may reproduce the functionality of the CMP flag-producing instruction 134 and the CMPEQ flag-consuming instruction 140 without including operands representing an immediate value of zero.

With continuing reference to FIG. 7, generation of a fused instruction is illustrated in an example where the immediate value operands of a flag-producing instruction and a flag-consuming instruction fetched from the instruction stream 18 of FIG. 1 are reversed. Detected first in a detected instruction stream 156 is a CMP flag-producing instruction 158, which sets the condition code 36 in the status register 34 of FIG. 1 based on a comparison of a value in a register R₁ designated by an operand 160, and an immediate value of zero designated by an operand 162. Note that the CMP flag-producing instruction 158 is provided herein as a non-limiting example, and that some embodiments may provide one or more other flag-producing instructions.

Following the CMP flag-producing instruction 158 in the detected instruction stream 156 is a CMPEQ flag-consuming instruction 164. The CMPEQ flag-consuming instruction 164 consumes the flag result in the condition code 36 by applying an EQ condition 165 to the flag result. It is to be understood that the EQ condition 165 is provided herein as a non-limiting example, and that some embodiments may provide a flag-consuming instruction employing a different condition or operation. The EQ condition 165 evaluates to true if the Z bit of the condition code 36 is set, and false if the Z bit is clear. If the EQ condition 165 evaluates to true, the CMPEQ flag-consuming instruction 164 executes the indicated operation. In this example, the operation indicated by the CMPEQ flag-consuming instruction 164 compares values stored in a register R₂ designated by an operand 166 with an immediate value having a hexadecimal value of 0x08 designated by an operand 168. It is to be understood that the immediate value 0x08 designated by the operand 168 is a non-limiting example, and that the operand 168 may designate any immediate value permitted by the instruction set architecture.

A fused instruction 170 illustrates the results of processing the CMP flag-producing instruction 158 and the CMPEQ flag-consuming instruction 164 by the instruction processing circuit 14 of FIG. 1. As shown in FIG. 7, the fused instruction 170 is a CMPPEQ4 (“compare (paired) if equal”) instruction that incorporates logic for performing the operations of the CMP flag-producing instruction 158 and the CMPEQ flag-consuming instruction 164. Accordingly, the CMPPEQ4 fused instruction 170 is distinct from other fused instructions that perform other combinations of instructions and/or operands, such as the CMPPEQ3 fused instruction 148 discussed above.

The CMPPEQ4 fused instruction 170 generates a flag result by comparing a register R₁ indicated by an operand 172 with an immediate value of zero (not shown). As noted above with respect to the CMPPEQ3 fused instruction 148, the logic underlying the CMPPEQ4 fused instruction 170 may be optimized to enable the CMPPEQ4 fused instruction 170 to perform the operations of the CMP flag-producing instruction 158 and the CMPEQ flag-consuming instruction 164 without including operands representing an immediate value of zero. Accordingly, in this example, the immediate value of zero designated by the operand 162 of the CMP flag-producing instruction 158 is omitted as an operand for the CMPPEQ4 fused instruction 170. The CMPPEQ4 fused instruction 170 then consumes the flag result by applying an EQ condition 173, corresponding to the EQ condition 165 of the CMPEQ flag-consuming instruction 164, to the flag result. If the EQ condition 173 evaluates to true, the CMPPEQ4 fused instruction 170 compares a register R₂ designated by an operand 174 with an immediate value having a hexadecimal value of 0x08 designated by an operand 176.

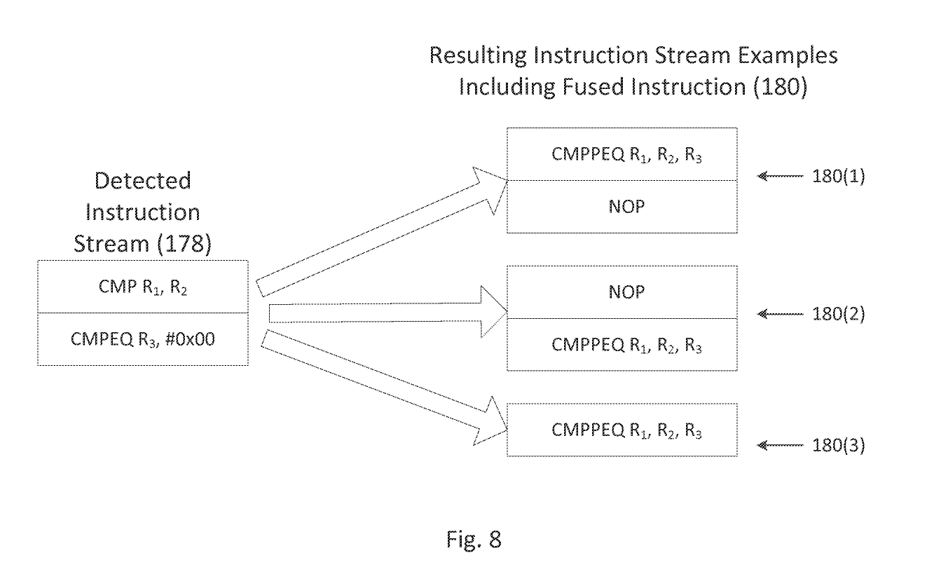

As noted above with respect to FIG. 4B, either the flag-producing instruction or the flag-consuming instruction is replaced in the instruction stream by the generated fused instruction. The instruction that is not replaced by the generated fused instruction is rendered extraneous by the generated fused instruction, and therefore may be replaced by an instruction indicating no operation (i.e., NOP) or removed entirely from the instruction stream. Thus, the instruction processing circuit may process a given detected instruction stream into different resulting instruction streams that include the generated fused instruction. In this regard, FIG. 8 shows an exemplary detected instruction stream 178 including a flag-producing instruction and a flag-consuming instruction, and corresponding resulting instruction stream examples 180(1)-180(3) that may be generated by the instruction processing circuit 14 of FIG. 1. In this example, the detected instruction stream 178 includes a CMP flag-producing instruction that generates a flag result by comparing the values of registers R₁ and R₂, followed by a CMPEQ flag-consuming instruction that consumes the flag results, and compares the value of register R₃ with an immediate value of zero if the EQ condition applied to the flag result evaluates to true.

Resulting instruction stream examples 180 illustrate exemplary sequences of instructions, including fused instructions, into which the instructions in the detected instruction stream 178 may be processed by the instruction processing circuit 14 of FIG. 1. In some embodiments, the CMP flag-producing instruction in the detected instruction stream 178 may be replaced with the fused instruction, and the CMPEQ flag-consuming instruction may be replaced with an instruction indicating no operation (i.e., NOP). Accordingly, exemplary instruction stream 180(1) comprises a fused instruction CMPPEQ, followed by an NOP.

Some embodiments may provide that the CMP flag-producing instruction in the detected instruction stream 178 may be replaced with an NOP instruction, while the CMPEQ flag-consuming instruction is replaced with the fused instruction. Thus, in instruction stream 180(2), an NOP instruction is followed by the fused instruction CMPPEQ.

In some embodiments described herein, either the CMP flag-producing instruction or the CMPEQ flag-consuming instruction will be replaced by the generated fused instruction, and the instruction that is not replaced will be removed entirely from the instruction stream. Accordingly, instruction stream 180(3) comprises only the fused instruction CMPPEQ.

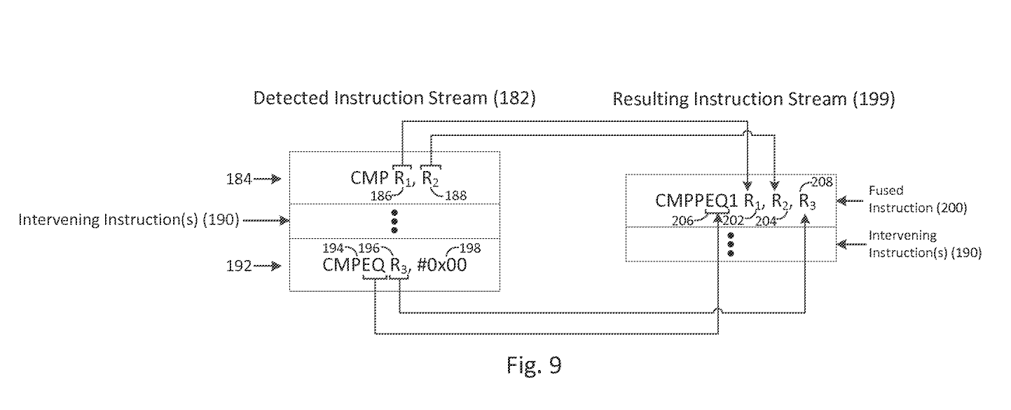

As mentioned above with respect to FIG. 4A, the flag-producing and flag-consuming instructions used to generate a fused instruction may be fetched adjacent to one another from the instruction stream, or they may be separated in the instruction stream by other intervening instructions. With respect to the latter scenario, FIG. 9, with reference to FIG. 1, illustrates an exemplary conversion of non-consecutive flag-producing and flag-consuming instructions into a fused instruction. In FIG. 9, a detected instruction stream 182 depicts a series of instructions detected by the instruction processing circuit 14 as the instruction stream 18 of FIG. 1 is processed. Detected first in the detected instruction stream 182 is a flag-producing instruction 184, which in this example is the ARM architecture CMP instruction. The CMP flag-producing instruction 184 sets the condition code 36 in the status register 34 of FIG. 1 based on a comparison of values represented by operands 186 and 188. Here, the operands 186 and 188 designate two of the registers 16(0)-16(M) of FIG. 1, referred to as registers R₁ and R₂, respectively. Note that the CMP flag-producing instruction 184 is provided herein as a non-limiting example, and that some embodiments may provide one or more other flag-producing instructions.

Following the CMP flag-producing instruction 184 in the detected instruction stream 182 is at least one intervening instruction 190. The at least one intervening instruction 190 may be any valid instruction, other than an instruction that results in an occurrence of a disqualifying condition. As discussed above with respect to FIGS. 4A and 5, a disqualifying condition may be any condition that makes it impossible to guarantee that both or neither of the flag-producing instruction and a subsequent flag-consuming instruction will be executed. Examples of such disqualifying conditions may include an instruction that modifies the flag result and a branch instruction that alters the flow of the computer program.

Further along in the detected instruction stream 182 of FIG. 9 is a flag-consuming instruction 192, which is the ARM architecture CMPEQ instruction. The CMPEQ flag-consuming instruction 192 consumes the flag result stored in the condition code 36 by applying an EQ (equals) condition 194 to the flag result. It is to be understood that the EQ condition 194 is provided herein as a non-limiting example, and that some embodiments may provide a flag-consuming instruction employing a different condition or operation. As noted above in Table 1, the EQ condition 194 evaluates to true if the Z bit of the condition code 36 is set, and false if the Z bit is clear. If the EQ condition 194 evaluates to true, the CMPEQ flag-consuming instruction 192 then carries out the indicated operation. In this example, the operation indicated by the CMPEQ flag-consuming instruction 192 compares a value stored in one of the registers 16(0)-16(M) designated by an operand 196 (referred to in this example as register R), and an immediate value of zero designated by an operand 198. Note that, in this example, the CMPEQ flag-consuming instruction 192 is also a flag-producing instruction, because the CMPEQ flag-consuming instruction 192 generates a new flag result in the condition code 36 if the EQ condition 194 applied to the original flag result evaluates to true. However, in some embodiments, a flag-consuming instruction may indicate an operation that consumes a flag result without generating a new flag result.

An exemplary resulting instruction stream 199 including a fused instruction 200 illustrates the results of processing the CMP flag-producing instruction 184, the intervening instructions 190, and the CMPEQ flag-consuming instruction 192 by the instruction processing circuit 14 of FIG. 1. In this example, the fused instruction 200 is a CMPPEQ1 (“compare (paired) if equal”) instruction discussed above with respect to FIG. 6. The CMPPEQ1 fused instruction 200 incorporates logic for performing the operations of both the CMP flag-producing instruction 184 and the CMPEQ flag-consuming instruction 192. Accordingly, the CMPPEQ1 fused instruction 200 is distinct from other fused instructions that perform the operations of other combinations of instructions and/or operands.

The CMPPEQ1 fused instruction 200 generates a flag result by comparing the values in the registers R₁ and R₂ designated by operands 202 and 204, respectively. The CMPPEQ1 fused instruction 200 then consumes the flag result by applying an EQ condition 206, corresponding to the EQ condition 194 of the CMPEQ flag-consuming instruction 192, to the flag result. If the EQ condition 206 evaluates to true, the CMPPEQ1 fused instruction 200 compares the value in the register R₃, designated by an operand 208, to an immediate value of zero (not shown). As seen in FIG. 9, the resulting instruction stream 199 includes the intervening instructions 190 following the CMPPEQ1 fused instruction 200, indicating that the CMP flag-producing instruction 184 was replaced by the CMPPEQ1 fused instruction 200. In some embodiments, the CMPEQ flag-consuming instruction 192 may be replaced by the CMPPEQ1 fused instruction 200. In such embodiments, therefore, the intervening instructions 190 may precede the CMPPEQ1 fused instruction 200 in the resulting instruction stream 199. By performing the operations of both the CMP flag-producing instruction 184 and the CMPEQ flag-consuming instruction 192 with a single instruction, the CMPPEQ1 fused instruction 200 ensures that the operations are executed within the same execution pipeline 12, thereby avoiding the potential for a read-after-write hazard and associated consequences caused by dependencies between the instructions in a pipelined computing architecture.

As shown in this example, the immediate value of zero designated by the operand 198 of the CMPEQ flag-consuming instruction 192 is omitted as an operand for the CMPPEQ1 fused instruction 200. In some embodiments, the number of operands that may be associated with the CMPPEQ1 fused instruction 200 are limited by hardware constraints. Accordingly, the logic underlying the CMPPEQ1 fused instruction 200 may be optimized in such a way that the CMPPEQ1 fused instruction 200 may reproduce the functionality of the CMP flag-producing instruction 184 and the CMPEQ flag-consuming instruction 192 without including operands representing an immediate value of zero.

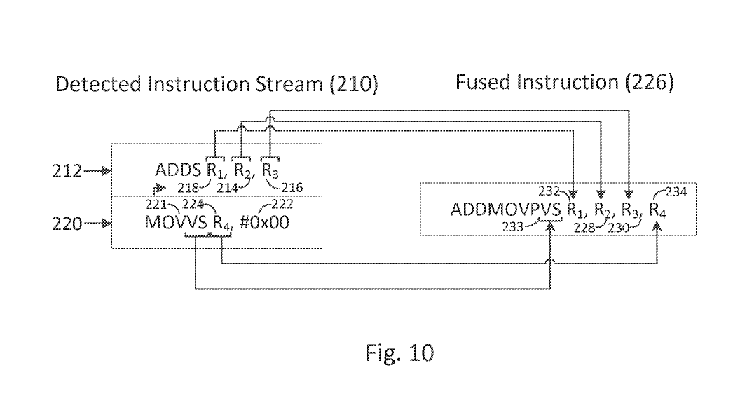

FIG. 10, with reference to FIG. 1, illustrates a further exemplary fused instruction generated based on flag-producing and flag-consuming instructions according to some embodiments. In FIG. 10, a detected instruction stream 210 depicts a series of instructions detected by the instruction processing circuit 14 as the instruction stream 18 of FIG. 1 is processed. Detected first in the detected instruction stream 210 of FIG. 10 is a flag-producing instruction 212, which in this example is the ARM architecture ADDS instruction. The ADDS flag-producing instruction 212 adds the values in two of the registers 16(0)-16(M) of FIG. 1 designated by operands 214 and 216 (referred to as source registers R₂ and R₃), and stores the result in one of the registers 16(0)-16(M) designated by an operand 218 and referred to as result register R₁. The ADDS flag-producing instruction 212 also generates a flag result by setting the condition code 36 in the status register 34 based on the result of adding the values in source registers R₂ and R₃. For instance, if the result is zero, the Z bit of the condition code 36 is set, and if the result causes an arithmetic overflow, the V bit of the condition code 36 is set.

Further along in the detected instruction stream 210 is a flag-consuming instruction 220, which in this example is the ARM architecture MOVVS instruction. The MOVVS flag-consuming instruction 220 consumes the flag result stored in the condition code 36 by applying a VS (overflow) condition 221 to the flag result. It is to be understood that the VS condition 221 is provided herein as a non-limiting example, and that some embodiments may provide a flag-consuming instruction employing a different condition or operation. The VS condition 221 evaluates to true if the V bit of the condition code 36 is set, and false if the V bit is clear. If the VS condition 221 evaluates to true, the MOVVS flag-consuming instruction 220 carries out the indicated operation. In this example, the operation indicated by the MOVVS flag-consuming instruction 220 moves an immediate value of zero designated by an operand 222 into one of the registers 16(0)-16(M) designated by an operand 224 and referred to as result register R₄. Note that, in this example, the MOVVS flag-consuming instruction 220 does not generate a new flag result. However, it is to be understood that, in some embodiments, a flag-consuming instruction may indicate an operation that consumes a flag result and also generates a second flag result.

A fused instruction 226 illustrates the results of processing the ADDS flag-producing instruction 212 and the MOVVS flag-consuming instruction 220 by the instruction processing circuit 14 of FIG. 1. As shown in FIG. 10, the fused instruction 226 is a ADDMOVPVS (“add and move (paired) if overflow”) instruction that incorporates logic for performing the operations of both the ADDS flag-producing instruction 212 and the MOVVS flag-consuming instruction 220. Accordingly, the ADDMOVPVS fused instruction 226 is distinct from other fused instructions that perform the operations of other combinations of instructions and/or operands. The ADDMOVPVS fused instruction 226 adds the values stored in source registers R₂ and R₃ designated by operands 228 and 230, respectively, and stores the result in result register R₁ designated by an operand 232. The ADDMOVPVS fused instruction 226 also generates a flag result by setting the condition code 36 based on the result of adding the values in source registers R₁ and R₃. The ADDMOVPVS fused instruction 226 then consumes the generated flag results by applying a VS condition 233, corresponding to the VS condition 221, to the flag result. If the VS condition 233 evaluates to true, the ADDMOVPVS fused instruction 226 moves an immediate value of zero (not shown) into the result register R₄ designated by an operand 234. By performing the operations of both the ADDS flag-producing instruction 212 and the MOVVS flag-consuming instruction 220 with a single instruction, the ADDMOVPVS fused instruction 226 ensures that the operations are executed within the same execution pipeline 12, thereby removing the potential for a read-after-write hazard and associated consequences caused by dependencies between the instructions in a pipelined computing architecture.

In this example, the ADDMOVPVS fused instruction 226 is depicted as utilizing four operands indicating registers R₁-R₄ (R₂ and R₃ as source registers, and R₁ and R₄ as result registers). It is to be understood that, in some embodiments, hardware constraints may limit the number of operands that may be associated with the ADDMOVPVS fused instruction 226 to fewer than four. For similar reasons, the immediate value of zero designated by the operand 222 of the MOVVS flag-consuming instruction 220 may be omitted as an operand for the ADDMOVPVS fused instruction 226. The logic underlying the ADDMOVPVS fused instruction 226 may be optimized in such a way that the ADDMOVPVS fused instruction 226 may reproduce the functionality of the ADDS flag-producing instruction 212 and the MOVVS flag-consuming instruction 220 without including operands representing an immediate value of zero.

The instruction processing circuits fusing flag-producing and flag-consuming instructions according to embodiments disclosed herein may be provided in or integrated into any processor-based device. Examples, without limitation, include a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

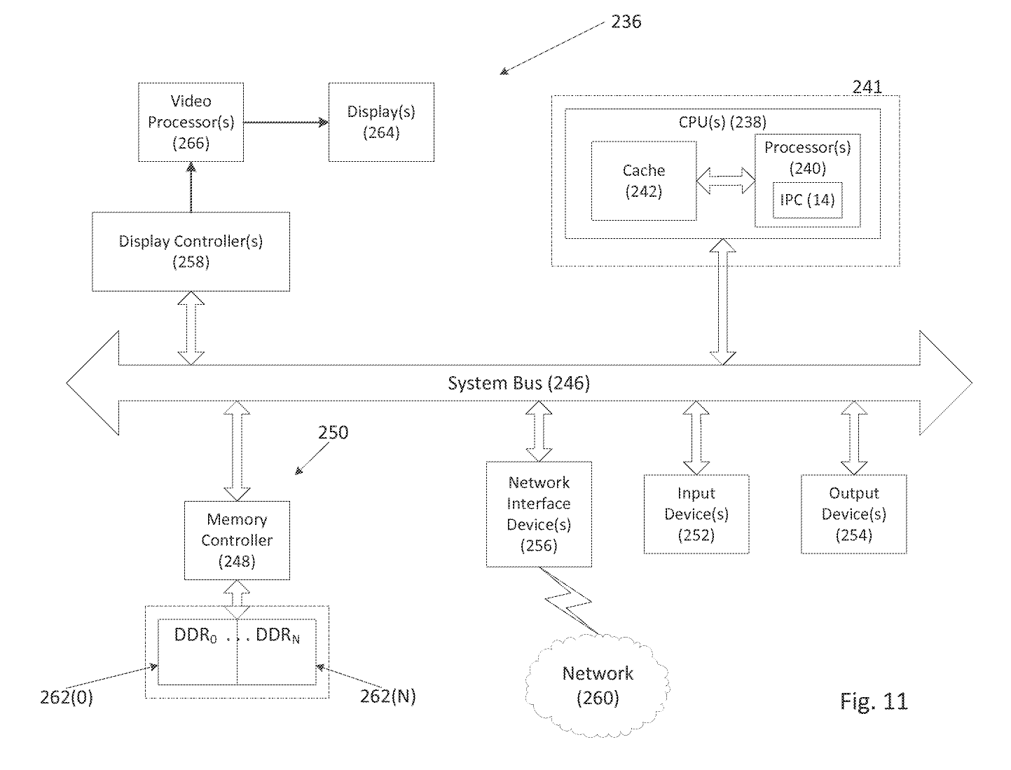

In this regard, FIG. 11 illustrates an example of a processor-based system 236 that can employ the instruction processing circuit 14 illustrated in FIG. 1. In this example, the processor-based system 236 includes one or more central processing units (CPUs) 238, each including one or more processors 240. The processor(s) 240 may comprise the instruction processing circuit (IPC) 14, and may be integrated into a semiconductor die 241. The CPU(s) 238 may have cache memory 242 coupled to the processor(s) 240 for rapid access to temporarily stored data. The CPU(s) 238 is coupled to a system bus 246 and can intercouple master and slave devices included in the processor-based system 236. As is well known, the CPU(s) 238 communicates with these other devices by exchanging address, control, and data information over the system bus 246. For example, the CPU(s) 238 can communicate bus transaction requests to a memory controller 248, as an example of a slave device. Although not illustrated in FIG. 11, multiple system buses 246 could be provided.

Other master and slave devices can be connected to the system bus 246. As illustrated in FIG. 11, these devices can include a memory system 250, one or more input devices 252, one or more output devices 254, one or more network interface devices 256, and one or more display controllers 258, as examples. The input device(s) 252 can include any type of input device, including but not limited to input keys, switches, voice processors, etc. The output device(s) 254 can include any type of output device, including but not limited to audio, video, other visual indicators, etc. The network interface device(s) 256 can be any device(s) configured to allow exchange of data to and from a network 260. The network 260 can be any type of network, including but not limited to a wired or wireless network, a private or public network, a local area network (LAN), a wide local area network (WLAN), and the Internet. The network interface device(s) 256 can be configured to support any type of communication protocol desired. The memory system 250 can include one or more memory units 262(0)-262(N).

The CPU(s) 238 may also be configured to access the display controller(s) 258 over the system bus 246 to control information sent to one or more displays 264. The display controller(s) 258 sends information to the display(s) 264 to be displayed via one or more video processors 266, which process the information to be displayed into a format suitable for the display(s) 264. The display(s) 264 can include any type of display, including but not limited to a cathode ray tube (CRT), a liquid crystal display (LCD), a plasma display, etc.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The master devices and slave devices described herein may be employed in any circuit, hardware component, integrated circuit (IC), IC chip, or semiconductor die, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a processor, a DSP, an Application Specific Integrated Circuit (ASIC), an FPGA or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g. a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flow chart diagrams may be subject to numerous different modifications as will be readily apparent to one of skill in the art. Those of skill in the art would also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

What is claimed is:

1. An instruction processing circuit, configured to:
detect a flag-producing instruction in an instruction stream indicating a first operation generating a first flag result;
detect a flag-consuming instruction in the instruction stream indicating a second operation consuming the first flag result as an input; and
generate a fused instruction indicating the first operation generating the first flag result and indicating the second operation consuming the first flag result as the input.

2. The instruction processing circuit of claim 1, configured to detect the flag-producing instruction indicating the first operation setting one or more condition code flags.

3. The instruction processing circuit of claim 1, configured to detect the flag-consuming instruction located adjacent to the flag-producing instruction in the instruction stream.

4. The instruction processing circuit of claim 1, further configured to:
detect at least one intervening instruction in the instruction stream between the flag-producing instruction and the flag-consuming instruction; and
determine whether a disqualifying condition occurs during processing of the at least one intervening instruction;
the instruction processing circuit configured to generate the fused instruction if no disqualifying condition occurs during processing of the at least one intervening instruction.

5. The instruction processing circuit of claim 1, configured to detect the flag-producing instruction indicating the first operation having a sole effect of generating the first flag result.

6. The instruction processing circuit of claim 1, configured to detect the flag-consuming instruction indicating the second operation consuming the first flag result and generating a second flag result.

7. The instruction processing circuit of claim 1, configured to detect the flag-consuming instruction indicating the second operation consuming the first flag result, wherein the second operation is a non-flag-producing operation.

8. The instruction processing circuit of claim 1, disposed in a circuit comprised from the group consisting of: an instruction fetch circuit, an instruction decode circuit, and an optional instruction queue.

9. The instruction processing circuit of claim 1, further configured to:
select one of the flag-producing instruction or the flag-consuming instruction as a selected instruction based on an instruction selection flag; and
replace the selected instruction in the instruction stream with the fused instruction.

10. The instruction processing circuit of claim 9, further configured to:
replace the flag-producing instruction or the flag-consuming instruction not corresponding to the selected instruction in the instruction stream with an instruction indicating no operation.

11. The instruction processing circuit of claim 9, further configured to:
remove the flag-producing instruction or the flag-consuming instruction not corresponding to the selected instruction from the instruction stream.

12. The instruction processing circuit of claim 1 integrated into a semiconductor die.

13. The instruction processing circuit of claim 1, further comprising a device into which the instruction processing circuit is integrated selected from the group consisting of: a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

14. An instruction processing circuit, comprising:
a means for detecting a flag-producing instruction in an instruction stream indicating a first operation generating a first flag result;
a means for detecting a flag-consuming instruction in the instruction stream indicating a second operation consuming the first flag result as an input; and
a means for generating a fused instruction indicating the first operation generating the first flag result and indicating the second operation consuming the first flag result as the input.

15. A method for processing computer instructions, comprising:
detecting a flag-producing instruction in an instruction stream indicating a first operation generating a first flag result;
detecting a flag-consuming instruction in the instruction stream indicating a second operation consuming the first flag result as an input; and
generating a fused instruction indicating the first operation generating the first flag result and indicating the second operation consuming the first flag result as the input.

16. The method of claim 15, wherein the first operation comprises setting one or more condition code flags.

17. The method of claim 15, wherein the first operation has a sole effect of generating the first flag result.

18. The method of claim 15, wherein the second operation consumes the first flag result and generates a second flag result.

19. The method of claim 15, wherein the second operation is a non-flag-producing operation that consumes the first flag result.

20. A non-transitory computer-readable medium having stored thereon computer-executable instructions to cause a processor to implement a method comprising:
detecting a flag-producing instruction in an instruction stream indicating a first operation generating a first flag result;
detecting a flag-consuming instruction in the instruction stream indicating a second operation consuming the first flag result as an input; and
generating a fused instruction indicating the first operation generating the first flag result and indicating the second operation consuming the first flag result as the input.

21. The non-transitory computer-readable medium of claim 20 having stored thereon the computer-executable instructions to cause the processor to implement the method wherein the first operation comprises setting one or more condition code flags.

22. The non-transitory computer-readable medium of claim 20 having stored thereon the computer-executable instructions to cause the processor to implement the method wherein the first operation has a sole effect of generating the first flag result.

23. The non-transitory computer-readable medium of claim 20 having stored thereon the computer-executable instructions to cause the processor to implement the method wherein the second operation consumes the first flag result and generates a second flag result.

24. The non-transitory computer-readable medium of claim 20 having stored thereon the computer-executable instructions to cause the processor to implement the method wherein the second operation is a non-flag-producing operation that consumes the first flag result.
